(19) United States
(12) Patent Application Publication
(10) Pub. No.: US 2006/0216672 A1
(43) Pub. Date: Sep. 28, 2006

(54) Jaw implant

(76) Inventor: Wolfgang Dinkelacker, Sindelfingen (DE)

Correspondence Address: KUDIRKA & JOBSE, LLP, ONE STATE STREET, SUITE 800, BOSTON, MA, 02109, US

(21) Appl. No.: 10/552,229

(22) PCT Filed: Apr. 17, 2003
(86) PCT No.: PCT/EP03/04073

§ 371 Date: Oct. 7, 2005

(51) Int. Cl. A61C 8/00

(52) U.S. Cl. 433/173

(57) ABSTRACT

A jaw implant has an implant body (30) which is attached by a screw (35) to an implant top portion (34). A borehole in the implant top portion forms a passage for the shaft of the screw and a supporting area for the screw head. The supporting area is designed as a truncated cone (40) and the part of the screw head coming to rest against it is designed as a female taper (39). By tightening the screw, the implant top portion is centered on the implant body without thereby exerting any pressure on the circumference of the implant top portion. The implant top portion is elastically deformable to a predetermined extent under the pressure of the tightened screw in the interface area between the implant body and the implant top portion, so that the interface profile of the implant top portion is adapted to the interface profile of the implant body. The elastically deformed implant top portion creates a restoring force which secures the screw in the tightened state to prevent it from loosening.

### SCOPE OF THE INVENTION

The present invention relates to a jaw implant having an implant body and an implant top portion connected to the implant body by a screw, said implant top portion serving as a carrier for a dental prosthesis.

### STATE OF THE ART

Known jaw implants consist of an implant body which is inserted into a borehole in the jawbone of the patient. After a healing phase, an implant top portion is attached to the implant body by a screw. The screw engages in a threaded borehole in the implant body, preferably running in the longitudinal axis of the implant body. The top portion serves as a carrier for an artificial dental prosthesis, for example, such as a dental crown or bridge. When attaching the implant top portion, it must be centered exactly with the longitudinal axis of the implant body. This may be accomplished with conical head of the fastening screw which cooperates with a conical recess in a borehole in the implant top portion through which the fastening screw passes. The recess is arranged concentrically with the axis of the borehole in the implant top portion. When the screw is tightened, its conical head comes to rest against the conical recess in the borehole of the implant top portion, bringing the implant top portion into a concentric position in relation to the longitudinal axis of the implant body. There may be a widening of the circumference of the implant top portion due to the conical effect; this may have negative effects in the case of jaw implants that are adapted to the anatomy of the jawbone in the area of the implant head in particular. In addition, the screw may become loosened due to the variable forces acting on the implant when chewing, so that secure seating of the top portion of the implant and a dental crown supported by it is no longer ensured. To eliminate this problem, a complex aftertreatment is necessary, consisting of removing the dental crown, tightening the connecting screw and re-attaching the dental crown.

Such an arrangement with the implant top portion centered on the implant body through the use of a cone is disclosed in U.S. Pat. No. 5,344,457. With one of the embodiments described there, the connecting screw has a second cone which is connected to the first cone with the opposite alignment and cooperates with a cover. The cover is integrated into a bridge construction and is placed with it onto the connecting screw and centered by the second cone. The cover is secured by another screw which engages in a threaded bore in the cover. This additional screw has a countersunk head whose cone engages in a corresponding conical recess in the cover. Therefore, when the additional screw is tightened, the circumference of the covering cap may be widened due to the double effect of the second cone and the conical recess, so this may have a negative effect on the connection between the covering cap and the bridge construction.

### SUMMARY OF THE INVENTION

This invention relates to a jaw implant having an implant body and an implant top portion attached to the implant body by a screw said implant top portion serving as a carrier for a dental prosthesis and having a borehole comprising a through-borehole for the shaft of the screw and a supporting area for the screw head. As defined in the claims, the contact area is designed as a truncated cone which surrounds the through-borehole and cooperates with a similarly designed female taper of the screw head. The truncated cone and the female taper cause the top portion of the implant to be centered with the longitudinal axis of the implant body when the screw is tightened without thereby exerting pressure on the circumference of the implant top portion. Instead, due to the truncated cone and the female taper, a pressure component aimed in the direction of the axis of the implant is generated, causing the implant top portion to be centered and controlling the elastic deformation of the implant top portion.

The implant top portion is elastically deformable in the interface area between the implant body and the implant top portion under the pressure of the tightened screw to the extent that the interface profile of the implant top portion is adapted to the interface profile of the implant body. In doing so, the pressure component directed in the direction of the implant axis counteracts widening of the circumference of the implant body on all sides. The implant top portion which undergoes elastic deformation under the pressure of the screw exerts a restoring force on the screw so that the screw is secured to prevent loosening after the screw is tightened.

According to a preferred embodiment of the inventive jaw implant, inclined edges on the lingual and buccal sides in the interface area of the implant body form an angle α greater than angle α′ between corresponding inclinations on the buccal side and on the lingual side in the interface area of the top portion of the implant. The difference between the angles α and α′ is such that it is within the elastic deformability range of the implant top portion. Under the pressure of the screw, the angle α′ is increased and the angle α is adjusted.

In an alternative embodiment of the inventive jaw implant, rounded areas on the buccal side and on the lingual side of the top portion of the implant have smaller radii of curvature in the interface area between the implant body and the top portion of the implant than do the corresponding rounded areas on the buccal side and on the lingual side in the interface area of the implant body. The difference in curvature here is such that it is within the elastic deformability range of the top portion of the implant. Under the pressure of the screw, the curvature in the interface area of the top portion of the implant is increased until it comes to rest against the curvature in interface area.

### DESCRIPTION OF THE DRAWINGS

Various embodiments of this invention are illustrated below on the basis of drawings, which show:

FIG. 1 a sectional diagram of an embodiment of the jaw implant according to this invention with a planar interface between the implant body and the top portion of the implant;

FIG. 2 a sectional diagram of another embodiment of the jaw implant according to this invention with an anatomically profiled interface between the implant body and the top portion of the implant;

FIG. 3 an exploded diagram of an implant of the type illustrated in FIG. 2;

FIG. 4 a partial sectional view of a modification of the embodiment according to FIG. 3;

FIG. 5 an exploded diagram of another embodiment of the implant according to this invention with an interface between the implant body and the top portion of the implant having a rounded profile; and

FIG. 6 an exploded diagram of another embodiment of the implant according to this invention with an interface between the implant body and the top portion of the implant having bell-shaped profile.

### DETAILED DESCRIPTION OF THE EXEMPLARY EMBODIMENTS OF THE INVENTION AS ILLUSTRATED IN THE DRAWINGS

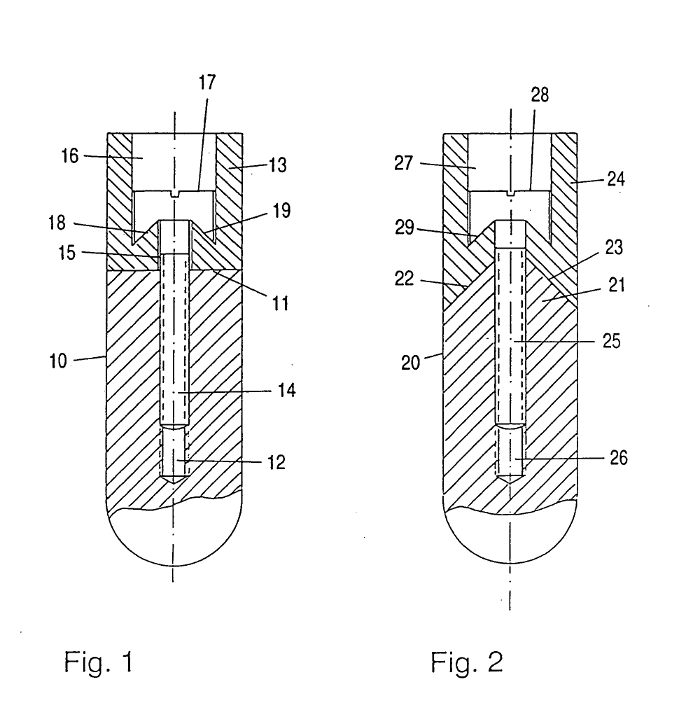

FIG. 1 shows a jaw implant 10 having a planar implant head 11 in a longitudinal sectional diagram. The implant 10 is preferably made of titanium or a titanium alloy. To anchor the implant in the jaw, a system of grooves and cylindrical gradations (not shown) as disclosed in EP-A-1013236 may be provided on the circumference of the implant. Instead of that, the implant body may also be designed as a screw. The implant 10 is designed to be cylindrical in the embodiment shown in FIG. 1 and has a central threaded borehole 12 in the direction of its longitudinal axis. After insertion of the implant into the jawbone, a healing phase of a few months begins. After this period of time a top portion 13 of the implant is attached to the implant 10, using a fastening screw 14 which is screwed into the threaded borehole 12. The implant top portion 13 serves as a carrier of a crown (not shown) or as a carrier of a bridge or crowns jointly together with other implants. The top portion 13 has a through-borehole 15 for the shaft of the screw 14 and a cylindrical recess 16 arranged coaxially with the through-borehole 15 to accommodate a screw head 17, the diameter of which is slightly smaller than the inside diameter of the recess 16. The base of the recess 16 is designed as a truncated cone 18 surrounding the through-borehole 15 and cooperating with a corresponding female taper 19 on the screw head 17. The female taper 19 is formed by an undercut underside of the screw head 17, which may also be referred to as a negative cone. The two cones 18, 19 have essentially the same apex angle. In the exemplary embodiment shown here, the apex angle measured between the lateral surface of the truncated cone 18 and the axis of the cylindrical recess 14 is 45 degrees. The female taper 19 also has essentially the same apex angle.

The cones 18, 19 with their lateral surfaces increase the contact area of the screw head 17 with the base of the recess 16. They therefore also enlarge the frictional surface between the screw 15 and the top portion 13 of the implant. The enlarged frictional area together with the clamping effect induced by the cones 18, 19 results in an increased self-locking effect of the tightened screw to prevent loosening.

When tightening the screw 14, the top portion 13 of the implant is centered with the longitudinal axis of the implant body 10 by means of the cones 18, 19 on the flat implant head 11. This is accomplished through the action of a component of the pressing force between the top portion 13 of the implant and the implant body 10, said component being directed toward the axis of the top portion and being created by the cones 18, 19. A radial pressure in the direction of the periphery of the top portion 13 of the implant and thus a widening of its circumference are thereby prevented. The risk of such a widening results from the fact that the material of which the implant body and the implant top portion are made is in most cases elastically deformable. This is true to a particularly great extent of titanium or titanium alloys.

The centering pressure component created by the conical effect is important in particular with jaw implants which are equipped with an anatomically profiled interface between the implant body and the top portion of the implant. The interface here refers to the bordering area between the implant body and the top portion of the implant. An exemplary embodiment of such an implant is shown in FIG. 2. An implant body 20 is equipped with opposing inclined faces 22, 23 on the implant head 21 in the manner described in European Patent A 0868889, said faces declining toward the buccal side and the lingual side of the jawbone in the implanted state, so that the profile of the implant head 21 is adapted to the cone-shaped cross section of the jawbone. A top portion 24 of the implant is fitted to the inclined faces 22, 23 on its underside and is attached to it by a screw 25 which engages in a threaded borehole 26 in the implant body. The implant top portion 24 has a through-borehole for the screw 25 and coaxially with the former it has a cylindrical recess 27 to receive the head 28 of the screw 25. The design and arrangement of the parts 25-28 are the same as those described in conjunction with the implant according to FIG. 1. The supporting surface 29 between the screw head 28 and the implant top portion 24 is designed with a conical shape as in the case of the implant according to FIG. 1. When the screw 25 is tightened, the top portion 24 of the implant is pressed against the inclined faces 22, 23, thereby creating a lateral pressure which may result in broadening of the top portion 24 toward the buccal and lingual side. On the other hand, the centering pressure component created by the conical pressure surface 29 counteracts the lateral pressure so that widening of the circumference of the top portion 24 of the implant is prevented.

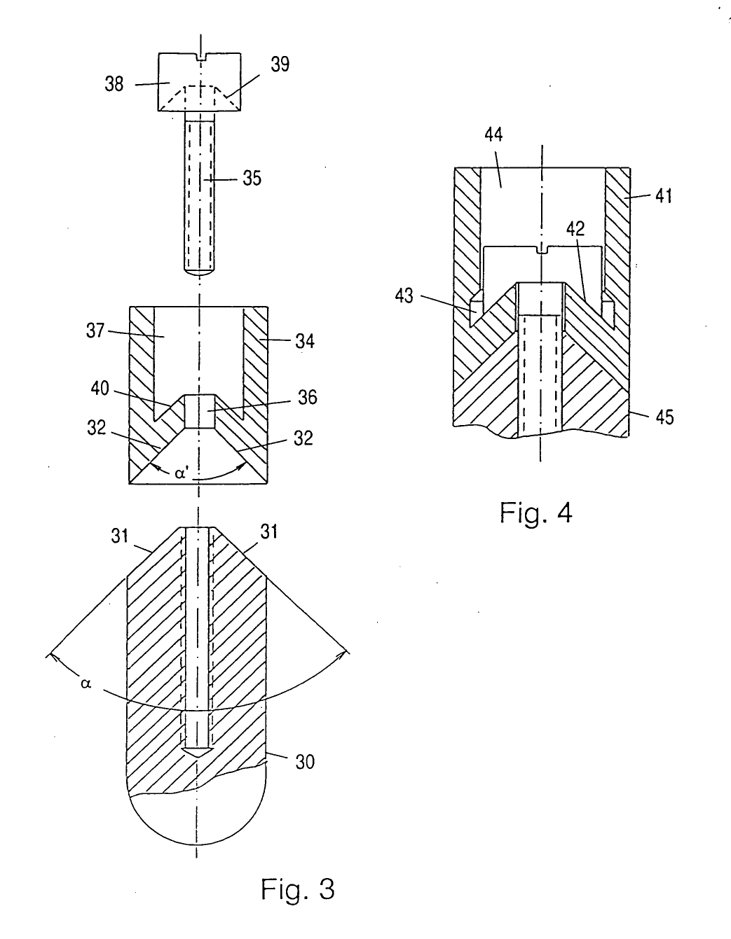

In the case of the implant according to FIG. 2, there is also a self-locking effect for the fastening screw 25 as described above. This effect is strengthened by appropriate dimensioning of the angle between the inclined faces 22, 23 on the implant head and the angle between the corresponding inclined faces on the top portion 24 of the implant. When the angle between the inclined faces 22, 23 on the implant head is selected to be slightly larger than the angle between the corresponding inclined faces on the bottom side of the top portion of the implant, a force-locking deformation of the top portion of the implant occurs when the screw 25 is tightened until the two parts are in contact with one another. The restoring force which then acts like a spring on the screw 25 results in an increased self-locking effect of the tightened screw to prevent loosening. This is described in greater detail below on the basis of the exemplary embodiment in FIG. 3.

The jaw implant according to FIG. 3 has an implant of the type depicted in FIG. 2, shown here as a longitudinal sectional view in an exploded diagram. An implant body 30 has inclined faces 31 on its buccal and lingual sides on the head of the implant body, matching up with corresponding inclined faces 32 in an implant top portion 34 which is connected to the implant body 3 by a screw 35. The implant top portion 34 has a through-borehole 36 and, coaxially with the latter, a cylindrical recess 37 to receive the head 38 of the connecting screw 35. On its bottom side, the screw head 38 has a female taper 39 which comes to rest on a truncated cone 40 when the screw 35 is tightened. The truncated cone 40 is at the base of the recess 37 and surrounds the through-bore 36. The inclined faces 31 on the implant body 30 are arranged at an angle α to one another. Likewise, the inclined faces 32 on the implant top portion 34 are arranged at an angle α′ to one another, this angle being smaller than the angle α (α′<α). The difference between the angles is within the elastic deformability of the implant top portion 34, amounting to 1 degree, for example. When the screw 35 is tightened, the angle α′ is spread until the angle α is reached and the inclined faces 32 come to rest against the inclined faces 31. This elastic deformation creates a restoring force acting on the screw head 38, causing a permanent locking effect of the tightened screw 35 to prevent it from loosening spontaneously. The slight spreading of the circumference of the top portion 34 of the implant which occurs with the spreading of the implant top portion 34 is compensated in the laboratory in the production of the dental prosthesis.

FIG. 4 shows an implant top portion 41, with a truncated cone 42 ending in a ring groove 43 arranged in a recess 44. The ring groove 43 has the profile of a parallelogram, one flank of which is formed by the surface of the truncated cone 42 which corresponds in arrangement and function to the truncated cone 40 in FIG. 3. The base area of the truncated cone 42 is enlarged by the ring groove 43, and the deformability of the implant top portion in the area of the interface with the implant body 45 is increased.

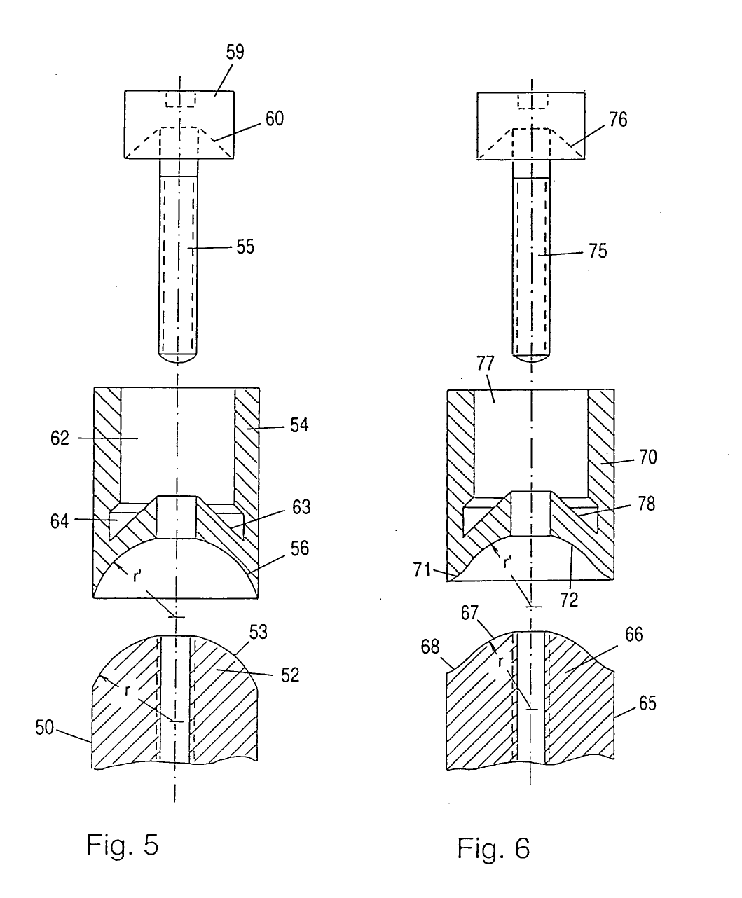

The jaw implant according to FIG. 5 has an implant body 50 with an implant head 52 comprising a rounded convex surface toward the buccal side and the lingual side. The rounded convex surface 53 may be composed of multiple radii or, as illustrated in the embodiment according to FIG. 5, it may be in the form of a segment of a circle. However, the rounded surface may also be designed as a section of a sphere or as an aspherical surface. An implant top portion 54, which may be attached to the implant body 50 by a screw 55, has a corresponding concave rounded surface 56 in the area of its interface with the implant body 50, corresponding to the concave rounded shape on the implant head 52. In the embodiment depicted here, the concave rounded shape 56 has a radius of curvature r′ which is slightly smaller than the radius of curvature r of the convex rounded shape 53. The difference in curvature is of a dimension such that it is within the range of the elastic deformability of the implant top portion 54. It preferably amounts to a few hundredths of a millimeter. When tightening the screw 55, the concave rounded surface 56 is widened until the concave rounded surface 56 comes to lie against the convex rounded shape of the implant head 53. This deformation of the top portion 54 of the implant creates a restoring force on the screw 55 which has a female taper 60 on the screw head 59 cooperating with the truncated cone 63 in the recess 62 of the implant top portion 54. This arrangement corresponds to the arrangement described in conjunction with FIG. 3 and FIG. 4. To increase the elastic deformability of the implant top portion 54 in the area of the interface to the implant body 50, a ring groove 64 may be provided in the recess 62, corresponding to the groove 41 in FIG. 4. However, this is not obligatory. In any case, the restoring force created by the elastic deformation causes a permanent locking effect of the tightened screw 55 to prevent it from becoming loosened.

The jaw implant depicted in FIG. 6 has an implant body 65 with a convex rounded implant head 66 on the buccal side and the lingual side with a convex part 67 developing into a concave part 68 on the circumference of the implant body, resulting in an approximately bell-shaped profile. An implant top portion 70 has a concave-convex profile 71, approximately bell-shaped, on its underside similar to this, its radii of curvature corresponding to those of the profile on the implant head 66. However, the radii of curvature of the concave-convex profile of the top portion 70 are slightly smaller in the concave part 72 than the radii of curvature of the convex part 67 of the implant head 66. In the exemplary embodiment in FIG. 6, the curvature of the convex part 67 consists of a circular segment having the radius r and the curvature of the concave part 72 consists of a segment of a circle having the radius r′, where r′<r. The difference in radii is such that it is within the range of the elastic deformability of the implant top portion 70. It preferably amounts to a few hundredths of a millimeter.

The other parts of the implant of FIG. 6 correspond to the similar parts of the implant in FIG. 5. A connecting screw 75 having a female taper 76 and a recess 77 with a truncated cone 78 in the implant top portion 70 are part of this. When the screw 75 is tightened, the concave-convex profile of the top portion 70 is widened until the concave part 72 is in contact with the convex part 67 of the implant head 66. This elastic deformation of the implant top portion 70 creates a permanent restoring force acting on the screw 75 in the manner described above, securing the screw to prevent it from loosening.

Although the present invention has been described on the basis of preferred embodiments, modifications and other embodiments may also be implemented without going beyond the scope of this invention as defined in the claims.

1. A jaw implant having an implant body and an implant top portion (13) which is attached to the implant body (10) by a screw (14) and serves as a carrier for a dental prosthesis and has a borehole which surrounds a through-borehole (15) for the connecting screw (14) and a recess (16) with a supporting area for the screw head (17),
characterized in that
the supporting area is designed as a truncated cone (18) surrounding the through-borehole (15) and the part of the screw head (17), which comes to rest against the truncated cone, is designed as a female taper (19) adapted to the truncated cone, and the truncated cone and the female taper cause a centering of the implant top portion (13) on the implant body (10) when the screw is tightened and at the same time prevent deformation of the implant top portion toward the outside.

2. The jaw implant according to claim 1, characterized in that the interface between the implant body (10) and the implant top portion (13) has an implant head (11) running at a right angle to the longitudinal axis of the implant body.

3. The jaw implant according to claim 1, characterized in that the interface between the implant body (20) and the implant top (24) has a profile adapted to the comb shape of the jaw.

4. The jaw implant according to claim 3, characterized in that the profile is inclined toward the buccal side and the lingual side.

5. The jaw implant according to claim 3, characterized in that the profile toward the buccal side and the lingual side is rounded, conforming to the shape of the cross section of the jaw.

6. The jaw implant according to claim 3, characterized in that the profile toward the buccal side and the lingual side has a bell shape (67, 68, 71, 72) approximating the shape of the cross section of the jaw.

7. The jaw implant according to claim 3, characterized in that the implant top (34) is elastically deformable under the pressure of the tightened screw (35) in the interface area.

8. The jaw implant according to claim 7, characterized in that in the interface area, the implant top (34) has a profile (32) which is adapted to the profile of the implant body (31) under the pressure of the screw (35).

9. The jaw implant according to claims 7 and 8, characterized in that the implant top (34), which undergoes elastic deformation in the interface area under the pressure of the screw (35), exerts a restoring force on the screw which secures the screw in the tightened state to prevent it from loosening spontaneously.

10. The jaw implant according to any one of claims 7 through 9, characterized in that a groove (43) running in a ring shape around the supporting area (truncated cone 42) is arranged in the recess (44) in the implant top (41) and increases the elastic deformability of the implant top in the interface area.

11. The jaw implant according to claim 10, characterized in that the ring groove (43) has a profile on which one flank is formed by the conical surface of the truncated cone (42).

12. The jaw implant according to claims 8 and 9, characterized in that inclined faces (31) on the buccal side and on the lingual side in the interface area of the implant body (30) form an angle α which is larger than an angle α′ between corresponding inclined surfaces (32) on the buccal side and on the lingual side in the interface area of the implant top (34); and the difference between angles α and α′ is such that it is within the elastic deformability range of the implant top and angle α increases under the pressure of the screw (35) and is adapted to angle α′.

13. The jaw implant according to claims 8 and 9, characterized in that rounded surfaces (56) on the buccal side and the lingual side have smaller radii of curvature in the interface area of the implant top (54) than the corresponding rounded surfaces (53) on the buccal side and on the lingual side in the interface area of the implant body (50); and the difference in curvature is such that it is within the elastic deformability range of the implant top, and the curvature in the interface area of the implant top increases under the pressure of the screw (55) and is adapted to the curvature in the interface area of the implant body.

14. The jaw implant according to claim 13, characterized in that the rounded surfaces (56) in the interface area of the implant top (54) and the rounded surfaces (53) in the interface area of the implant body (50) are circular.

15. The jaw implant according to claims 8 and 9, characterized in that an approximately bell-shaped profile has smaller radii of curvature in the interface area of the implant top (70) in the concave part (72) than the corresponding convex part (67) of the approximately bell-shaped profile in the interface area of the implant body (65); and the difference in curvature is such that it is within the elastic deformability range of the implant top, and the curvature in the interface area of the implant top increases under the pressure of the screw (75) and is adapted to the curvature in the interface area of the implant body.

16. The jaw implant according to claim 13, characterized in that the concave part (72) in the interface area of the implant top portion (70) and the convex part (67) in the interface area of the implant body (65) are circular.
